(19) United States
(12) Patent Application Publication
(10) Pub. No.: US 2015/0333599 A1
(43) Pub. Date: Nov. 19, 2015

(54) ELECTRIC MACHINE

(71) Applicant: ROBERT BOSCH GMBH, Stuttgart (DE)

(72) Inventors: Gert Wolf, Affalterbach (DE); Gerlinde Weber, Schwieberdingen (DE); Alexander Shendi, Asperg (DE)

(21) Appl. No.: 14/654,304

(22) PCT Filed: Dec. 18, 2013
(86) PCT No.: PCT/EP2013/077222

§ 371 Date: Jun. 19, 2015

(30) Foreign Application Priority Data
Dec. 19, 2012 (DE) 10 2012 223 705.4

(51) Int. Cl. H02K 9/06; H02K 3/50; H02K 3/12; H02K 1/24; H02K 1/27

(52) U.S. Cl. CPC H02K 9/06; H02K 1/243; H02K 1/2706; H02K 3/12; H02K 3/50

(57) ABSTRACT

The invention relates to an electric machine (10) comprising a stator (16) that has a stator core (17). Said core has a substantially cylindrical opening (60) having a central axis (63), an internal diameter (D17i) and an external diameter (D17a) and the opening (60) accommodates a rotor (20). The stator core (17) has an axial length (L17a) and said core (17) holds a stator winding (18) together with the rotor (20) which has a rotational axis (66). The rotor (20) has an axial end face (69), on which a fan (30) with fan blades (72) is located and is non-rotatably connected to the rotor (20). The rotor (20) has an electromagnetically excitable path (75) having a pole shank (78), a respective pole plate (22, 23) adjoining each axially rotational end (80, 82) of said shank. Claw poles (24) having a north polarity extend from one pole plate (22) and claw poles (25) having a south polarity extend from the other pole plate (23), said claw poles (24, 25) alternating between north and south polarities around the periphery of the rotor (20). The electromagnetic path (75) between two opposite-facing sides (69, 90) of the pole plates (22, 23) has an axially rotational length (L75), the ratio of the axial length (L17a) of the stator core (17) to the axially rotational length (L75) of the electromagnetic path (75) of the rotor (20) being between 0.68 and 1.0. The pole shank (78) has a diameter (D78) and an axially rotational length (L78), and a ratio of the axially rotational length (L78) of the pole shank (78) to the diameter (D78) of the pole shank (78) is between 0.21 and 0.36. The ratio of the internal diameter (D17i) of the stator core (17) to the external diameter (D17a) of the stator core (17) is greater than 0.788 and less than 0.854.

### BACKGROUND OF THE INVENTION

EP 910155A1 discloses an electric machine in the form of a so-called claw-pole generator. This electric machine has a stator and a rotor, wherein differently polarized field poles or claw poles which are arranged adjacent to one another over the circumference of the rotor generate a stator voltage in a stator winding of the stator during a rotary movement. The field poles of this machine are in the form of so-called claw poles.

The object of the invention consists in achieving a marked reduction in the mass of copper in an electric machine. Whilst maintaining the efficiency and the power output, both the weight of the field winding and the weight of the stator winding are reduced. Furthermore, the power density can be markedly increased.

### BRIEF DESCRIPTION OF THE DRAWINGS

In the figures:

FIG. 1 shows a longitudinal section through an electric machine,

FIG. 2 shows a side view of a stator core,

FIG. 3 shows a schematic view of a developed outer circumference of the rotor,

FIG. 4 shows interspaces between two claw pole magnet wheels, in which a permanently magnetic device is inserted,

FIG. 4A shows a profile of the no-load voltage and of a full-load current as a function of a variable structure condition of the machine,

FIG. 5 shows a side view of an end winding and the coverage thereof by a fan,

FIG. 6 shows a side view of a slot in a stator,

FIG. 7 shows a graph in which the standardized output current at 1800 rpm as a function of length ratios and diameter ratios of the magnetic circuit is considered,

FIG. 8 shows a further graph in which the standardized output current at 1800 rpm as a function of other length ratios of the magnetic circuit is considered,

FIG. 9 shows a stator core in a further enlarged front view,

FIG. 10 shows a graph in which a ratio of an output current at 1800/min is related to a ratio of stator core geometries,

FIG. 11 shows a graph in which a ratio of the current to the copper mass used is plotted against a ratio of the axial length of the stator core to the rotationally axial length of the electromagnetic path.

### DETAILED DESCRIPTION

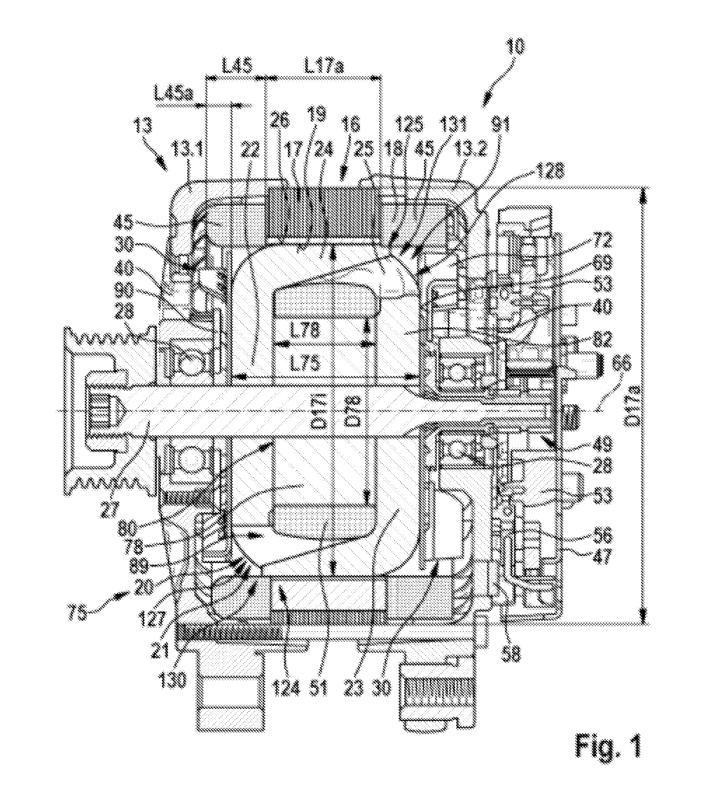

FIG. 1 shows a cross section through an electric machine 10, in this case in the embodiment as a generator or an AC generator, in particular a three-phase generator, for motor vehicles. This machine could operate with corresponding control or else as a starter-generator. This electric machine 10 has, inter alia, a two-part housing 13, which comprises a first end plate 13.1 and a second end plate 13.2. The end plate 13.1 and the end plate 13.2 accommodate a so-called stator 16 in them, said stator comprising a stator core 17 which is substantially in the form of a circular ring, with a stator winding 18 being introduced into the slots in said stator core which are directed radially inwards and extend axially. This ring-shaped stator 16, with its slotted surface pointing radially inwards, which surface is an electromagnetically effective surface 19, surrounds a rotor 20, which in this case is in the form of a claw-pole rotor, for example.

The rotor 20 comprises, inter alia, two pole plates 22 and 23, with in each case claw-pole fingers extending in the axial direction as electromagnetically polarizable claw poles 24 and 25 being arranged on the outer circumference of said pole plates. The two pole plates 22 and 23 are arranged in the rotor 20 in such a way that their claw poles 24 and 25, respectively, which extend in the axial direction, alternate with one another over the circumference of the rotor 20. Accordingly, the rotor 20 likewise has an electromagnetically effective surface 26. This results in interspaces 21 which are magnetically required owing to the claw poles 24 and 25 alternating over the circumference, said interspaces also being referred to here as claw-pole interspaces. The rotor 20 is mounted rotatably by means of a shaft 27 and in each case one rolling bearing 28 located on in each case one rotor side in the respective end plates 13.1 and 13.2, respectively.

The rotor 20 has in total two axial end faces, on which in each case one fan 30 is fastened. This fan 30 consists substantially of a plate-shaped or disk-shaped section, from which fan blades emanate in a known manner. These fans 20 serve the purpose of enabling air exchange for example from an axial end side of the electric machine 10 through the interior of the electric machine 10 to an environment which is radially on the outside, via openings 40 in the end plates 13.1 and 13.2. For this purpose, the openings 40 are provided substantially at the axial ends of the end plates 13.1 and 13.2, via which cooling air is sucked into the interior of the electric machine 10 by means of the fan 30. This cooling air is accelerated radially outwards by the rotation of the fans 30 so that said cooling air can pass through the substantially ring-shaped end winding 45 which is permeable to cooling air. By virtue of this effect, the end winding 45 is cooled. The cooling air, once it has passed through the winding overhang or end winding 45 or once it has flowed around this end winding 45 through openings (not illustrated in FIG. 1 here), takes a path radially outwards.

The protective cap 47 which is illustrated in FIG. 1 and is located on the right-hand side of the generator protects various component parts from environmental influences. Thus, this protective cap 47 covers, for example, a so-called slip ring assembly 49, which serves the purpose of supplying field current to a field winding 51. A heat sink 53 is arranged around this slip ring assembly 49, said heat sink in this case acting as a positive heat sink. This positive heat sink is called a positive heat sink because it is electrically conductively connected to a positive terminal of a rechargeable battery (for example starter current supply). The end plate 13.2 acts as the so-called negative heat sink. A connection plate 56 is arranged between the end plate 13.2 and the heat sink 53 and serves the purpose of connecting negative diodes 58 arranged in the end plate 13.2 and positive diodes (not shown here in this illustration) in the heat sink 53 to one another and thus represents a bridge circuit known per se.

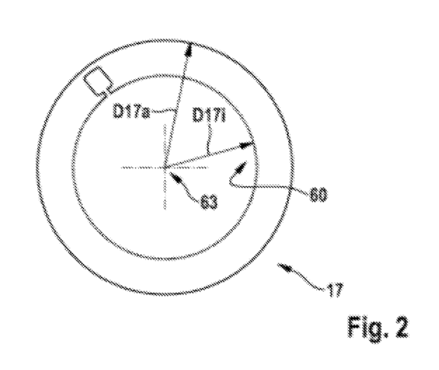

Accordingly, in FIG. 1 an electric machine 10 comprising a stator 16 which has a stator core 17 is disclosed. The stator core 17 has a substantially cylindrical opening 60 having a central axis 63 (see also FIG. 2). The opening 60 accommodates the rotor 20. The stator core 17 has an axial length L17a, and the stator core 17 holds the stator winding 18. In addition, the stator core 17 has an inner diameter D17i and an outer diameter D17a. The rotor 20 also has an axis of rotation 66, which in the fitted state coincides with the central axis 63.

The rotor 20 has an axial end side 69, on which a fan 30 with fan blades 72 is arranged. The fan is connected in rotationally fixed fashion to the rotor 20, preferably directly.

The rotor 20 has an electromagnetically excitable path 75, which has a pole core 78 adjoined at both rotationally axial ends 80, 82 by in each case one pole plate 22, 23. Claw poles 24 which have a north polarity emanate from one pole plate 22 and claw poles 25 which have a south polarity emanate from the other pole plate 23, wherein the claw poles 24 and 25 alternate according to north polarity and south polarity over the circumference of the rotor 20. The pole core 78 arranged radially within the claw poles 24, 25 has a rotationally axial length L78.

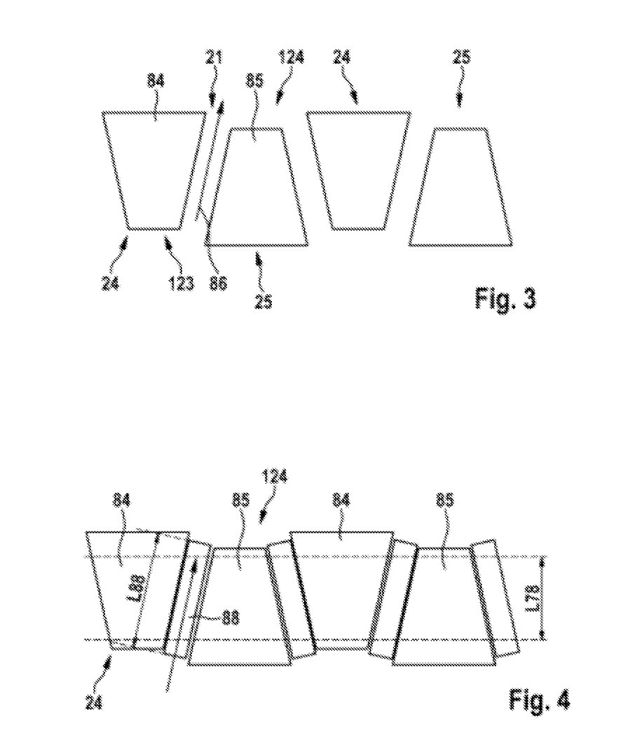

FIG. 3 shows a schematic view of a developed outer circumference of the rotor 20. The trapezoidal areas 84 and 85 of the claw poles 24 and 25 are shown, which conduct the electromagnetic flux over said trapezoidal areas as interface of the rotor 20 to the interfaces at teeth of the stator 16 or take it up from there. The rotor 20 has an interspace 21, already mentioned, having a longitudinal direction 86 between two adjacent claw poles 24, 25 of opposite polarity. The longitudinal direction 86 coincides with a central line between the claw poles 24 and 25. If the interspace is delimited, for example, by side faces of the claw poles 24 and 25 running parallel to one another, the central line runs in the center between the side faces of the claw poles 24 and 25.

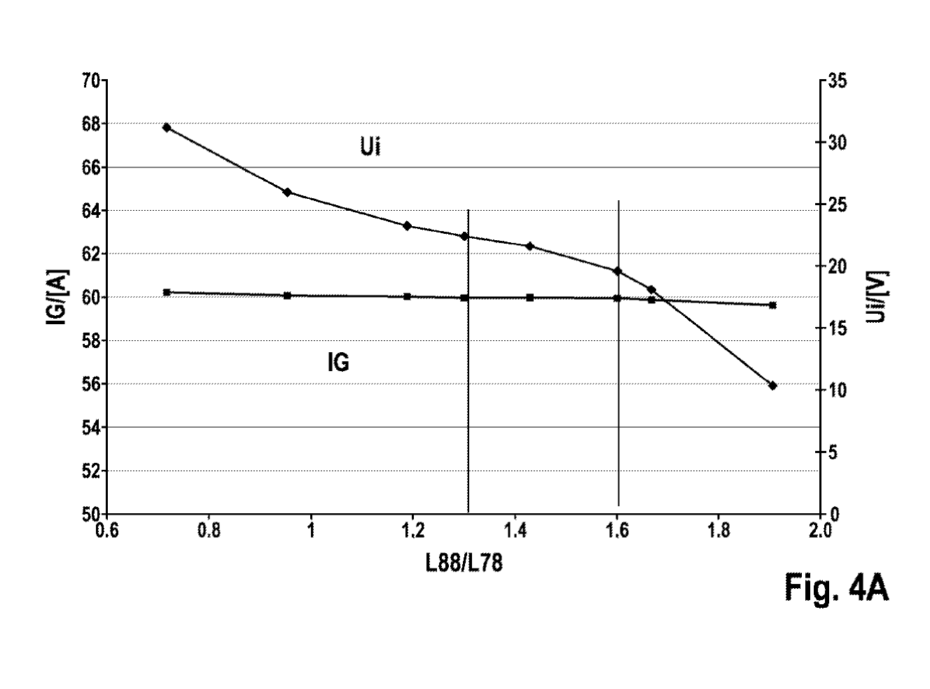

As shown in FIG. 4, a permanently magnetic device 88 is inserted in one interspace 21 between the two claw poles 24, 25. The permanently magnetic device 88 has a length L88 in the longitudinal direction 86 of the interspace 21 (excluding magnetically inactive sections such as holding elements). The permanently magnetic device 88 is used for compensation of electromagnetic or magnetic leakage flux between a claw pole 24 having north polarity and a claw pole 25 having south polarity. Provision is made for a ratio of the length L88 of the permanently magnetic device 88 to the rotationally axial length L78 of the pole claw to be greater than 1.3. That is to say that tips 123 and 124 of the claw poles 24 and 25 protrude into interspaces 89 and 91 of claw pole roots 130 and 131 of the same polarity in each case. In other words: one tip 123 of a claw pole 124 with north polarity protrudes between two claw pole roots 131 of two claw poles 125 having south polarity. A claw pole root is in this case restricted to the volume region which adjoins a freely protruding part of a claw pole 124, 125 in the axial direction. A corresponding graph is shown in FIG. 4A, which has been simulated taking into consideration permanent magnets. Firstly, by virtue of the ratio of L88/L78, the profile of the generated current IG on full load and a speed of the rotor of 1800/min is illustrated, and secondly this graph shows the profile of the induced voltage Ui off load and in the case of a field current IE of zero amperes in the stator winding 18 at 18000/min. The desired minimum ratio of L88/L78 of 1.3 is due to the inflection point of the profile of the induced voltage Ui. The desired preferred ratio of L88/L78 of >1.6 is due to the beginning severe drop in the profile of the induced voltage Ui. By virtue of the selection of the ratio L88/L78 >1.6, it is ensured that the voltage induced by the permanent magnets is less than the Zener voltage of the diodes. This is generally >20 V.

In one variant provision is made for a ratio of the length L88 of the permanently magnetic device 88 to the rotationally axial length L78 of the pole core 78 to be greater than 1.6.

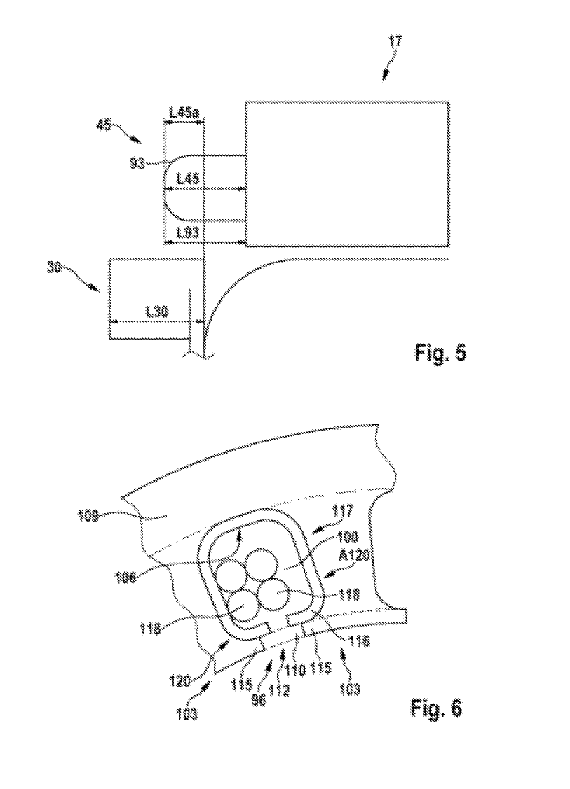

Furthermore, it is defined that the stator winding 18 has an end winding 45, which has a wired connection 93, which is passed away from the stator core 17 over a rotationally axial length L93 and is guided back towards said stator core. If the wired connection 93 under consideration is the most protruding wired connection 93 (FIG. 5), this is at the same time the rotationally axial length of the end winding L45. The fan 30 is arranged radially within the end winding 45 (FIG. 1 and FIG. 5). The region covered by the end winding 45 and the fan 30 together in the rotationally axial direction over the length L45a and in this case a proportion of the length L93 of the wired connection 93 which is covered rotationally axially by the fan 30 should be greater than 0.5, preferably greater than 0.7. The ratio of L45a to L45 or of L45a to L93 should therefore be greater than 0.5, preferably greater than 0.7.

The stator winding 18 is inserted in slots 96 in the stator core which are open radially inwards (FIG. 6). In this case an electromagnetically effective area 100 of the slot 96 is defined. The area 100 is delimited by the teeth 103 and the slot base 106 in the direction towards the yoke 109. An area 110 in the slot opening 112 between the two tooth tips 115 is not taken into consideration since, with this design, this space is not intended for the arrangement of a winding. Within the electromagnetically effective area 100 of the slot 96 and surrounded by a slot lining 116, there is in each case one electromagnetically effective winding arrangement 117 of the stator winding 18, which comprises coil sides 118 of a phase winding, for example. The winding arrangement 117 has at least one wire cross section 120 having an electrically effective wire cross-sectional area A120, wherein a ratio of the at least one wire cross-sectional area A120 and therefore of all of the wire cross sections 120 in a slot 96 to the electromagnetically effective area 100 is less than 0.5.

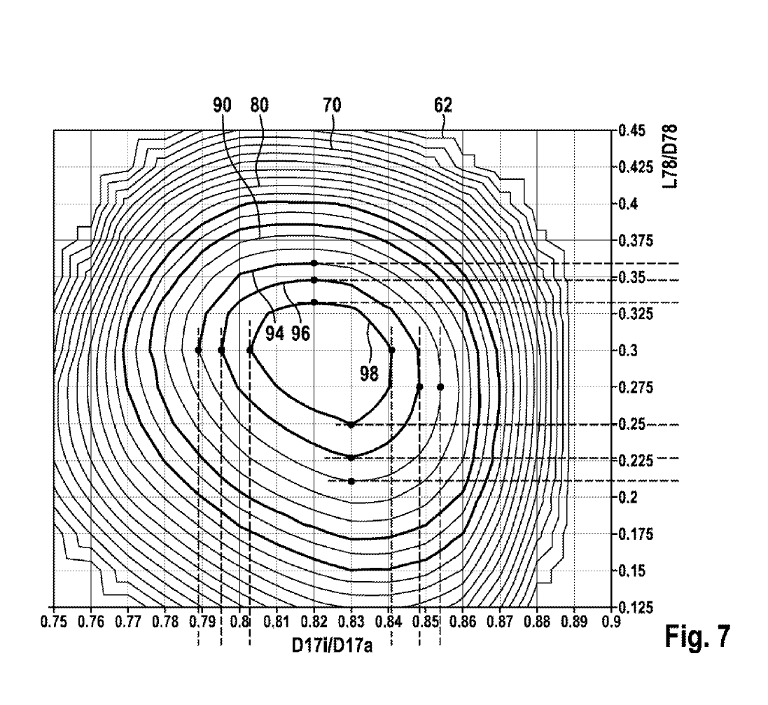

FIG. 7 shows a graph in which the computational ratio is specified for different variants of D17i and D17a (D17i/D17a) on the x axis. The pole core 78 has a diameter D78 and a rotationally axial length L78. The y axis labeled on the right-hand side in FIG. 7 specifies the ratio of L78 to D78 assumed for many variants. Within the scope of the configuration, various ratios have proven to be favorable: a ratio of the rotationally axial length L78 of the pole core 78 to the diameter D78 of the pole core 78 should be between 0.21 and 0.36, preferably between 0.225 and 0.348 and particularly preferably between 0.25 and 0.33. The ratio of the inner diameter D17i of the stator core 17 to the outer diameter D17a of the stator core 17 should be greater than 0.788 and less than 0.854, preferably greater than 0.795 and less than 0.848, and particularly preferably between 0.802 and 0.841 (see also FIG. 7, which has been simulated without taking into consideration permanent magnets).

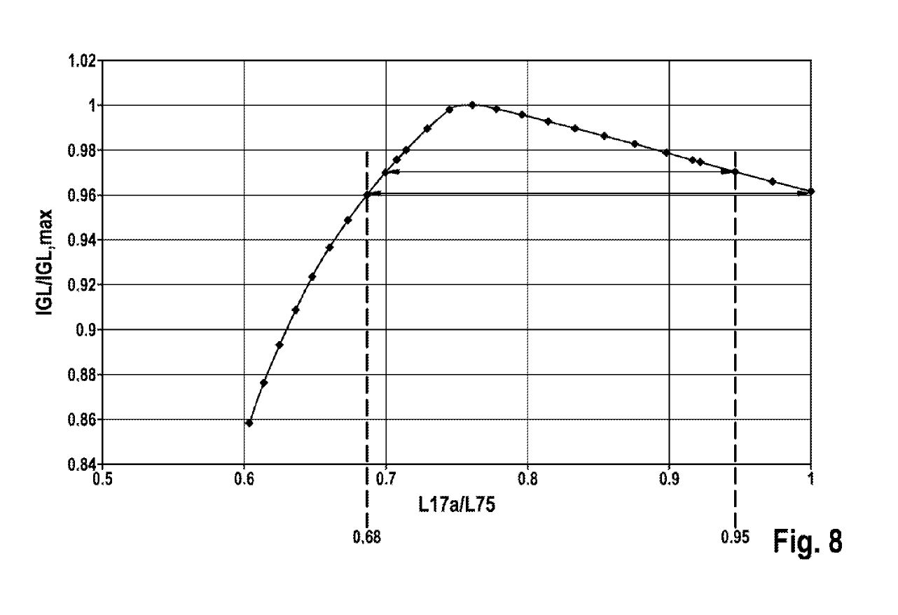

Provision is furthermore made for the electromagnetic path 75 between two mutually remote sides 69, 90 of the pole plates 22, 23 to have the rotationally axial length L75, wherein the ratio of the axial length L17a of the stator core 17 to the rotationally axial length L75 of the electromagnetic path 75 of the rotor 20 is between 0.68 and 1.0, preferably between 0.70 and 0.95 (FIG. 8). This figure has been simulated without taking into consideration permanent magnets. In said figure, the ratio of an output current IGL to a maximum output current IGL, max at 1800 rpm is plotted against the ratio of the length Ll7a of the stator core 17 to the rotationally axial length L75 of the electromagnetic path 75.

In one variant, provision is made for a ratio of the diameter D17i to the rotational axial length L78 of the pole core 78 to be greater than 5.0.

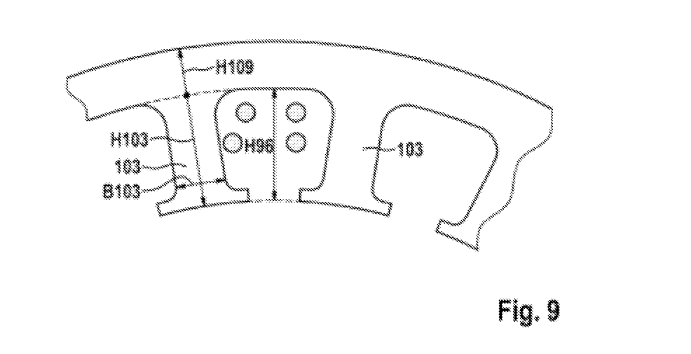

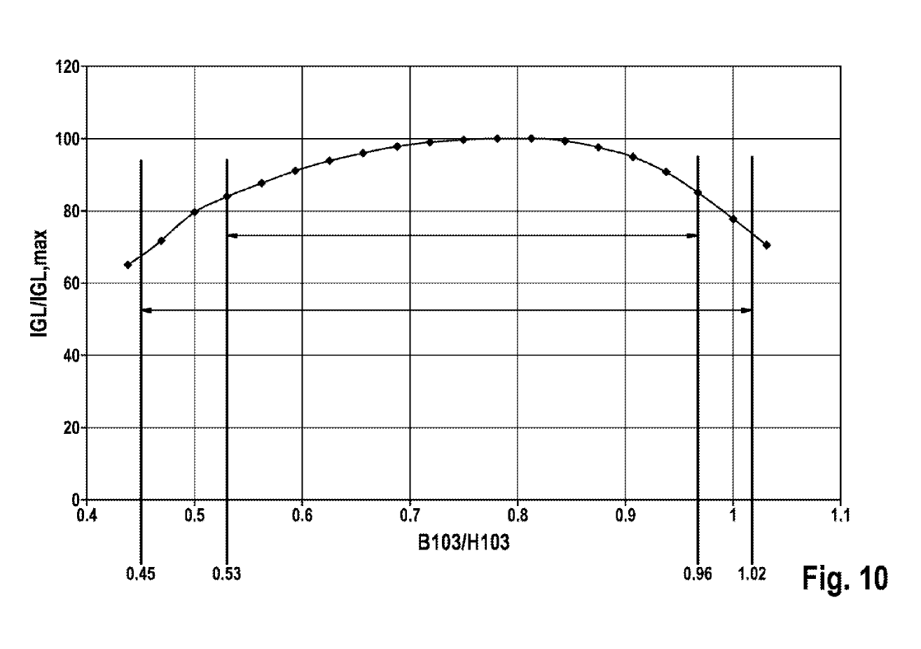

FIG. 9 shows the stator core 17 in a further enlarged end view. The stator core 17 holds, as already mentioned, the stator winding 18, which is accommodated in slots 96 which are open radially inwards. Each slot 96 is delimited in both circumferential directions by in each case one tooth 103, wherein the teeth 103 have a minimum tooth width B 103 in the circumferential direction and a tooth height H103 in a radial direction. A range of from 0.45 to 1.02 should apply for the ratio of the tooth height H103 to a minimum tooth width B103. Preferably, a range of from 0.53 to 0.96 should apply for the ratio of the tooth height H103 to a minimum tooth width B103 (FIG. 10). This figure has been simulated without taking into consideration permanent magnets.

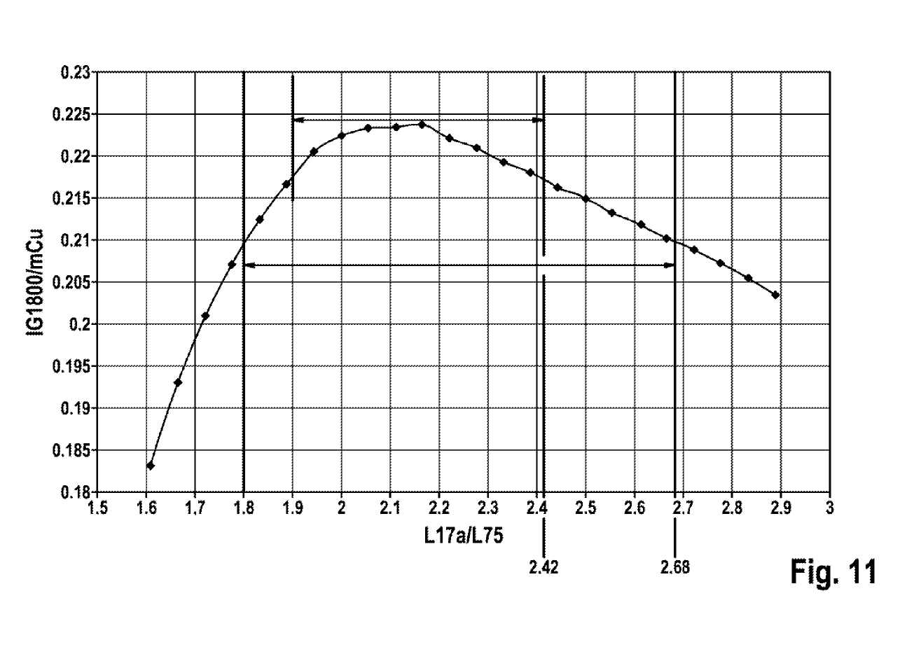

In connection with this last-mentioned configuration of the slot section, it should furthermore apply that a ratio of the axial length L17a of the stator core 17 to the rotational axial length L78 of the pole core 78 is greater than 1.8 and less than 2.68, preferably greater than 1.9 and less than 2.42 (FIG. 11). This figure has been simulated without taking into consideration permanent magnets.

The pole core 78 can be defined in various ways: the variant shown in FIG. 1 is a ring-cylindrical pole core 78, which has been pushed onto the shaft 27 and is separated from the pole plates 22, 23. Another known design provides a pole core 78 which is embodied from two corresponding shoulders, of which in each case one is integrally formed on the pole plates 22, 23. By pushing onto the shaft 27, wherein the two shoulders face one another, an equivalent pole core 78 is produced. The pole core length L78 is in this case the sum of the rotationally axial length of the shoulders.

It is moreover particularly preferred that the number of wire cross sections 120 per slot is precisely four.

In relation to the permanently magnetic device 88, the observation will be made that the interspaces 21 should be occupied or filled, where possible, completely with one or more permanent magnets as part of the permanently magnetic device 88. The permanent magnet(s) should be arranged centrally in the rotationally axial direction between the tips 123 and 124 of the claw poles 24 and 25. Furthermore, provision is made for the side faces 127 and 128 which are visible in FIG. 1, for example, to be processed, preferably from the tips 123 and 124 up to the claw pole roots 130 and 131 of the claw poles 24 and 25 for accommodating one or more permanent magnets either with or without the formation of chips, in particular in the longitudinal direction 86 of the interspace 21. In order to accommodate one or more permanent magnets, a holding element is provided as mechanical intermediate piece between a permanent magnet and a claw pole 24 and 25, said holding element being fastened on the claw pole 24 and/or 25 and itself in each case being used for holding a permanent magnet. The holding element can be arranged in slots individually in one piece between two claw poles 24 and/or 25 or can be a collective holder, which holds a plurality of permanent magnets in different interspaces 21. As a collective holder, this can be shaped in the form of a ring or in meandering fashion in the radial and/or axial direction. The permanent magnets themselves can be fewer in number than the number of claw poles 24 and 25, for example only half and in this case, for example, only in every second interspace 21, but can also be double the number of claw poles 24 and 25. The permanent magnets can be produced from ferrites or from rare earths.

1. An electric machine (10) comprising a stator (16), which has a stator core (17), which has a substantially cylindrical opening (60) having a central axis (63), and the stator core having an inner diameter (D17i) and an outer diameter (D17a), wherein the opening (60) receives a rotor (20), wherein the stator core (17) has an axial length (L17a), and the stator core (17) holds a stator winding (18), wherein the rotor (20), has an axis of rotation (66), and has an axial end side (69), on which a fan (30) with fan blades (72) is arranged, which fan is connected in rotationally fixed fashion to the rotor (20), wherein the rotor (20) has an electromagnetically excitable path (75), which has a pole core (78) adjoined by, at both rotationally axial ends (80, 82), in each case one pole plate (22, 23), wherein claw poles (24) which have a north polarity emanate from one pole plate (22) and claw poles (25) which have a south polarity emanate from the other pole plate (23), wherein the claw poles (24, 25) alternate according to north polarity and south polarity over a circumference of the rotor (20), and the electromagnetic path (75) has a rotationally axial length (L75) between two mutually remote sides (69, 90) of the pole plates (22, 23), wherein a ratio of the axial length (L17a) of the stator core (17) to the rotationally axial length (L75) of the electromagnetic path (75) of the rotor (20) is between 0.68 and 1.0, wherein the pole core (78) has a diameter (D78) and a rotationally axial length (L78), and a ratio of the rotationally axial length (L78) of the pole core (78) to the diameter (D78) of the pole core (78) is between 0.21 and 0.36, and wherein a ratio of the inner diameter (D17i) of the stator core (17) to the outer diameter (D17a) of the stator core (17) is greater than 0.788 and less than 0.854.

2. The electric machine as claimed in claim 1, characterized in that the ratio of the rotationally axial length (L78) of the pole core (78) and the diameter (D78) of the pole core (78) is between 0.225 and 0.348, and in that the ratio of the inner diameter (D17i) of the stator core (17) to the outer diameter (D17a) of the stator core (17) is greater than 0.795 and less than 0.848.

3. The electric machine as claimed in claim 2, characterized in that the ratio of the rotationally axial length (L78) of the pole core (78) to the diameter (D78) of the pole core (78) is between 0.25 and 0.33, and in that the ratio of the inner diameter (D17i) of the stator core (17) to the outer diameter (D17a) of the stator core (17) is greater than 0.802 and less than 0.841.

4. The electric machine as claimed in claim 1, characterized in that the ratio of the axial length (L17a) of the stator core (17) to the rotationally axial length (L75) of the electromagnetic path (75) of the rotor (20) is between 0.68 and 1.0.

5. The electric machine as claimed in claim 1, characterized in that the stator winding (18) has an end winding (45) which has a wired connection (93), which is passed over a rotationally axial length (L93) away from the stator core (17) and back towards said stator core, and in this case the fan (30) is arranged radially within and a proportion of the length (L93) of the wired connection (93) which is covered rotationally axially by the fan (30) is greater than 0.5.

6. The electric machine as claimed in claim 1, characterized in that a ratio of the inner diameter (D17i) of the substantially cylindrical opening (60) in the stator core (17) to the rotationally axial length (L78) of the pole core (78) is greater than 5.0.

7. The electric machine as claimed in claim 1, characterized in that the stator winding (18) is inserted into slots (96) in the stator core (17) which are open radially inwards, wherein the slots (96) each have an electromagnetically effective area (100) in which in each case one electromagnetically effective winding arrangement (117) of the stator winding (18) is located, wherein the winding arrangement (117) has at least one wire cross section (120) with an electrically active wire cross-sectional area (A120), and wherein a ratio of all of the wire cross sections (120) in a slot (96) of the at least one wire cross-sectional area (A120) to the electromagnetically effective area (100) is less than 0.5.

8. The electric machine as claimed in claim 1, characterized in that the rotor (20) has an interspace (21) having a longitudinal direction (86) between two adjacent claw poles (24, 25) of opposite polarity, wherein a permanently magnetic device (88) rests in one interspace (21) between the two claw poles (24, 25), said device being configured to compensate for a leakage flux between a claw pole (24) with north polarity and a claw pole (25) with south polarity.

9. The electric machine as claimed in claim 1, characterized in that the ratio of the axial length (L17a) of the stator core (17) to the rotationally axial length (L75) of the electromagnetic path (75) of the rotor (20) is between 0.70 and 0.95

10. The electric machine as claimed in claim 1, characterized in that the stator winding (18) has an end winding (45) which has a wired connection (93), which is passed over a rotationally axial length (L93) away from the stator core (17) and back towards said stator core, and in this case the fan (30) is arranged radially within and a proportion of the length (L93) of the wired connection (93) which is covered rotationally axially by the fan (30) is greater than 0.7.

11. The electric machine as claimed in claim 3, characterized in that the ratio of the axial length (L17a) of the stator core (17) to the rotationally axial length (L75) of the electromagnetic path (75) of the rotor (20) is between 0.68 and 1.0.

12. The electric machine as claimed in claim 11, characterized in that the stator winding (18) has an end winding (45) which has a wired connection (93), which is passed over a rotationally axial length (L93) away from the stator core (17) and back towards said stator core, and in this case the fan (30) is arranged radially within and a proportion of the length (L93) of the wired connection (93) which is covered rotationally axially by the fan (30) is greater than 0.5.

13. The electric machine as claimed in claim 12, characterized in that a ratio of the inner diameter (D17i) of the substantially cylindrical opening (60) in the stator core (17) to the rotationally axial length (L78) of the pole core (78) is greater than 5.0.

14. The electric machine as claimed in claim 13, characterized in that the stator winding (18) is inserted into slots (96) in the stator core (17) which are open radially inwards, wherein the slots (96) each have an electromagnetically effective area (100) in which in each case one electromagnetically effective winding arrangement (117) of the stator winding (18) is located, wherein the winding arrangement (117) has at least one wire cross section (120) with an electrically active wire cross-sectional area (A120), and wherein a ratio of all of the wire cross sections (120) in a slot (96) of the at least one wire cross-sectional area (A120) to the electromagnetically effective area (100) is less than 0.5.

15. The electric machine as claimed in claim 14, characterized in that the rotor (20) has an interspace (21) having a longitudinal direction (86) between two adjacent claw poles (24, 25) of opposite polarity, wherein a permanently magnetic device (88) rests in one interspace (21) between the two claw poles (24, 25), said device being configured to compensate for a leakage flux between a claw pole (24) with north polarity and a claw pole (25) with south polarity.
